(19) United States
(12) Patent Application Publication
(10) Pub. No.: US 2026/0180274 A1
(43) Pub. Date: Jun. 25, 2026

(54) METHOD AND APPARATUS FOR LASER-WELDING AT LEAST TWO CONDUCTOR PIECES, AND ASSEMBLY OF AT LEAST TWO INTEGRALLY BONDED CONDUCTOR PIECES

(71) Applicant: TRUMPF LASER SE, Schramberg (DE)

(72) Inventors: Oliver BOCKSROCKER, Sachsenheim (DE); Tim HESSE, Ditzingen (DE)

(21) Appl. No.: 19/539,056

(22) Filed: Feb. 13, 2026

Related U.S. Application Data
(63) Continuation of application No. PCT/EP2024/073376, filed on Aug. 20, 2024.

(30) Foreign Application Priority Data
Aug. 24, 2023 (DE) 10 2023 122 749.1

(51) Int. Cl. H01R 43/02; H01R 4/02

(52) U.S. Cl. CPC H01R 43/0221; H01R 4/029

(57) ABSTRACT

A method for laser-welding at least two conductor pieces includes providing an elongated first conductor piece having a first end portion and a first end face, and providing an elongated second conductor piece having a second end portion and a second end face. The first end face is arranged adjacent to the second end face. The method further includes producing a first laser spot on the first end face to produce a first weld pool, and producing a second laser spot on the second end face to produce a second weld pool. The first laser spot and the second laser spot are produced simultaneously. The first weld pool and the second weld pool subsequently merge to form a common weld pool.

### CROSS REFERENCE TO RELATED APPLICATIONS

This application is a continuation of International Application No. PCT/EP2024/073376 (WO 2025/040688 A1), filed on Aug. 20, 2024, and claims benefit to German Patent Application No. DE 10 2023 122 749.1, filed on Aug. 24, 2023. The aforementioned applications are hereby incorporated by reference herein.

### FIELD

Embodiments of the present invention relate to a method for laser-welding at least two conductor pieces, an assembly of at least two conductor pieces integrally bonded to one another, and an apparatus for laser-welding at least two conductor pieces.

### BACKGROUND

Welding conductor pieces by means of a laser beam is known from the prior art. A laser beam can be used to produce a weld pool that extends over all conductor pieces to be welded. For this purpose, the laser beam is moved back and forth between the individual conductor pieces. The disadvantage is that there is a gap between the conductor pieces to be welded, over which the laser beam is inevitably moved. This allows radiation to enter the gap and interact with material outside the welding zone (process zone). An interaction of the laser beam with material (e.g., the conductor piece) outside the welding zone is undesirable. Furthermore, the energy that is diverted into the gap is not available for the welding process.

Alternatively, a weld pool can be produced on each of the individual conductor pieces to be welded to one another. For this purpose, a laser beam can jump back and forth between the individual conductor pieces or melt pools. The separate weld pools on the individual conductor pieces grow and merge (when they are large enough) to form a common weld pool. The disadvantage is that switching between the individual melt pools leads to longer non-productive times.

### SUMMARY

Embodiments of the present invention provide a method for laser-welding at least two conductor pieces. The method includes providing an elongated first conductor piece having a first end portion and a first end face, and providing an elongated second conductor piece having a second end portion and a second end face. The first end face is arranged adjacent to the second end face. The method further includes producing a first laser spot on the first end face to produce a first weld pool, and producing a second laser spot on the second end face to produce a second weld pool. The first laser spot and the second laser spot are produced simultaneously. The first weld pool and the second weld pool subsequently merge to form a common weld pool.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a perspective view of end portions with end faces of two conductor pieces, with a laser spot arranged on each end face according to some embodiments; and

FIG. 2 schematically shows a top view of a laser spot according to FIG. 1, according to some embodiments.

### DETAILED DESCRIPTION

Embodiments of the present invention provide a method and an apparatus for laser-welding at least two conductor pieces and an assembly of at least two conductor pieces integrally bonded to one another, in which the above disadvantages are eliminated.

The conductor pieces can be electrically conductive elements, in particular made of metal (e.g., copper). The conductor pieces can be arranged in a stator of an electric machine. The conductor pieces can be designed for assembly in a stator of an electric machine. The conductor pieces, when arranged in a stator and electrically connected to one another, can be used to generate a magnetic field which is needed for operation of the electric machine.

The conductor pieces can be what are referred to as “hairpins”, which have two elongated (substantially parallel) legs connected to one another by means of a connecting portion. The shape of the hairpins usually corresponds to a hairpin. In other words, a hairpin has a (substantially) U-shaped form. The conductor pieces may also be what are referred to as “special pins” that only have one leg. A combination of “hairpins” and “special pins” is also conceivable. The conductor pieces can have a rectangular cross-section.

The method comprises the steps of:
providing an elongated first conductor piece having a first end portion and a first end face;
providing an elongated second conductor piece having a second end portion and a second end face. The first end face is arranged adjacent to the second end face;
producing a first laser spot on the first end face to produce a first weld pool;
producing a second laser spot on the second end face to produce a second weld pool. The first laser spot and the second laser spot are produced simultaneously. The first weld pool and the second weld pool then merge (if they are of sufficient size) to form a common weld pool;

The conductor pieces can be arranged on circular paths in a stator, with the conductor pieces protruding by their end portions from the stator. The end portions protruding from the stator can be oriented parallel to one another, in particular oriented in an axial direction of the stator.

The first laser spot and/or the second laser spot each have a core region and a ring region. The average laser power density in the core region is greater than the average laser power density in the ring region. The core region can be circular in shape. The ring region can be annular in shape. Other geometric configurations for the core region and/or the ring region are also conceivable, e.g., oval or elliptical.

This prevents a laser spot from moving across a gap located between the two end faces. This prevents any radiation from being directed into the gap. This prevents the laser radiation from interacting with material outside of a welding or process zone. All of the laser energy can be used for the welding process. In addition, the non-productive time caused by switching the laser beam between the individual melt pools is avoided or reduced.

Furthermore, this allows energy to be introduced in a targeted manner, thus optimizing the mixing in the weld pool. This can prevent or at least reduce the formation of spatter and/or pores.

According to one further development, the method can comprise the steps of:

moving the first laser spot on the first end face.

Alternatively or additionally, moving the second laser spot on the second end face. The first laser spot and/or the second laser spot can be moved by means of a scanner optical unit.

The scanner optical unit can comprise at least one ultra-lightweight mirror. The scanner optical unit can have a reproduction ratio of 1.7:1.

The first laser spot can be moved exclusively on the first end face. The second laser spot can be moved exclusively on the second end face. In other words, the first laser spot and the second laser spot are not moved beyond the respective end faces.

By moving the laser spots, a desired shape of the weld pool can be achieved. The energy can be specifically introduced into the conductor piece material. By moving the laser spots exclusively on the respective end faces, no laser power is lost, e.g., through radiation into the gap between the end faces, and can be used completely for the welding process. Furthermore, interaction between the laser and the material outside the end face (welding or process zone) is avoided.

According to a further development of the method, the first laser spot and/or the second laser spot can each be moved back and forth along a straight line. The straight line can be oriented in particular parallel to one of the edges of the end faces.

It is also conceivable that the first laser spot and/or the second laser spot can each be moved back and forth along a path that is at least partially curved.

This allows the energy to be distributed more effectively across the end face. In addition, a more uniform weld pool can be produced on the end face. Furthermore, the use of scanner optical unit, in particular with at least one ultra-light mirror, can further reduce non-productive time.

According to a further development of the method, the first laser spot and/or the second laser spot can each be moved along a circular or elliptical path. Other (closed) paths, e.g., rectangular, square, triangular, etc., are also conceivable.

This allows the laser power to be distributed more effectively over the end faces. In addition, a more uniform weld pool can be produced on the end face.

According to a further development of the method, the first laser spot and the second laser spot can be moved identically on their respective end faces. The two laser spots can be moved simultaneously and/or in the same way. The two laser spots can be moved along the same movement paths.

This allows for melt pools to be produced which are as similar as possible on the two end faces. This leads to the most uniform possible fusion of the two weld pools and to a common weld pool which is as uniform as possible.

According to a further development of the method, the first laser spot and/or the second laser spot can each be moved at a distance from an edge of the first end face and/or second end face. The distance of the first laser spot and/or the second laser spot from the edge of the first end face and/or second end face can, in particular, be the magnitude of at least the diameter of the first laser spot or the second laser spot. In other words, each laser spot is always arranged at a distance of at least one (own) laser spot diameter away from the nearest edge of the end face.

This ensures that the first laser spot and/or the second laser spot are always completely positioned on the respective end faces and that no laser power escapes outside the end faces.

According to a further development of the method, the first laser spot and the second laser spot can be produced by means of an optical multi-fiber. The optical multi-fiber can be designed as a 2-in-1 fiber. The first laser spot and the second laser spot can be identical. In particular, the two laser spots can have (substantially) identical beam properties.

The 2-in-1 fiber can have a core diameter of 50 μm (micrometers) and a ring diameter of 200 μm.

To generate the laser spots, a laser having a beam quality of BPP (beam parameter product) less than or equal to 4 mm*mrad (millimeters*milliradians) can be used.

The laser for generating the laser spots can be designed as a NIR (near-infrared) laser having a power greater than or equal to 4 kW (kilowatts), in particular of 8 kW.

This makes producing the first laser spot and the second laser spot as simple as possible.

According to a further development of the method, the first laser spot and the second laser spot can be produced using two laser beams guided parallel to one another.

The first laser spot and the second laser spot can be produced using two partial beams, with a first partial beam producing the first laser spot and a second partial beam producing the second laser spot. The two partial beams can be produced from a common laser beam, e.g., by an optical beam splitter, wedge plate, etc.

This makes it possible to produce the first laser spot and the second laser spot, which are identical, as simply as possible.

According to one further development, the method can comprise the steps of:

varying, in particular oscillating, the average laser power density of the first laser spot, its core region and/or its ring region. It is also conceivable that the average laser power density shifts continuously from the ring region to the core region, in particular at the start of the welding process. Furthermore, a continuous shift of the average laser power density from the core region to the ring region, in particular at the end of the welding process, is conceivable. In other words, an intensity ramp (increase in (average) intensity) of the laser power can be implemented between the core region and the ring region.

Alternatively or additionally, varying, in particular oscillating, the average laser power density of the second laser spot, its core region and/or its ring region. It is also conceivable that the average laser power density shifts continuously from the ring region to the core region, in particular at the start of the welding process. Furthermore, a continuous shift of the average laser power density from the core region to the ring region, in particular at the end of the welding process, is conceivable. In other words, an intensity ramp (increase in (average) intensity) of the laser power can be implemented between the ring region and the core region.

This can prevent or at least reduce the formation of pores and/or spatter during short process times.

According to one further development, the method can comprise the step of:

determining the position of the first laser spot and/or the second laser spot on the end face. This can be implemented by means of an optical sensor. The optical sensor can be camera-based. The optical sensor may be designed as a camera. Alternatively, the sensor can be designed as an interferometry-based sensor system.

This allows for position detection and/or position monitoring of the laser spot. Any potential positional deviation of the laser spot can thus be registered and/or corrected. This ensures and allows for the monitoring of consistent quality in welded joints.

Embodiments of the present invention also provide an assembly of at least two conductor pieces integrally bonded to one another. The integral bond is produced by means of a method as described above. In particular, the integral bond is a welded joint.

With regard to the advantages that can be achieved by it, reference is made to the relevant statements relating to the method. The measures described in connection with the method and/or those explained below can be used to further configure the assembly.

Embodiments of the present invention also provide an apparatus for laser-welding at least two conductor pieces.

The apparatus comprises at least one laser source. The laser source is configured to simultaneously produce a first laser spot and a second laser spot. The first laser spot and/or the second laser spot each have an, in particular circular, core region and an, in particular annular, ring region. In this case, the average laser power density in the core region is greater than the average laser power density in the ring region.

The apparatus has a control device for controlling the apparatus. The apparatus and/or the control device are configured to carry out the method as described above. The control device can be designed as a computer.

With regard to the advantages that can be achieved by it, reference is made to the relevant statements relating to the method. The measures described in connection with the method and/or those explained below can be used to further configure the apparatus.

A computer-readable storage medium is proposed, comprising commands which, when executed by a computer, cause it to carry out the method as described above. With regard to the advantages that can be achieved by it, reference is made to the relevant statements relating to the method. The measures described in connection with the method and/or those explained below can be used to further configure the storage medium.

A computer program is proposed, comprising commands which, when executed by a computer, cause it to carry out the method as described above. With regard to the advantages that can be achieved by it, reference is made to the relevant statements relating to the method. The measures described in connection with the method and/or those explained below can be used to further configure the computer program.

A data carrier signal is proposed that characterizes and/or transmits the computer program as described above. The data carrier signal can be received, for example, via an optional data interface of a computer. With regard to the advantages that can be achieved by it, reference is made to the relevant statements relating to the computer program. The measures described in connection with the computer program and/or those explained below can be used to further configure the data carrier signal.

In the following description and in the figures, corresponding components and elements have the same reference signs. For the sake of better clarity, all reference signs are not reproduced in all of the figures.

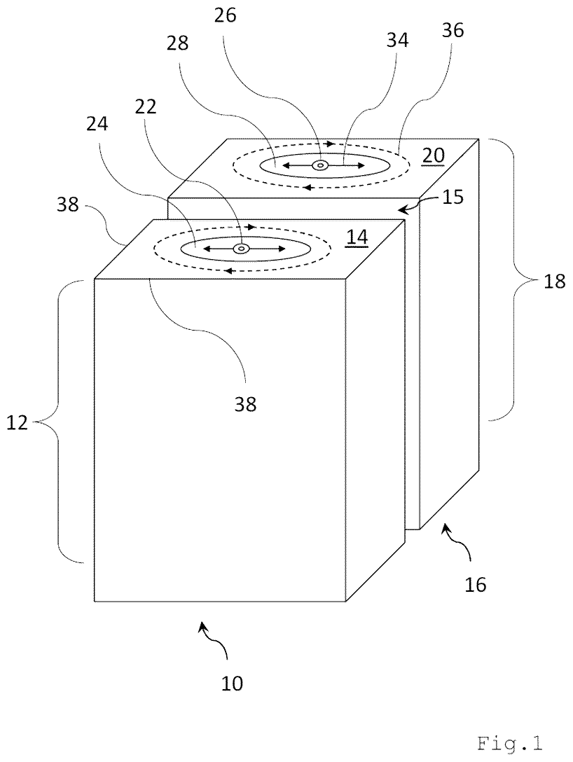

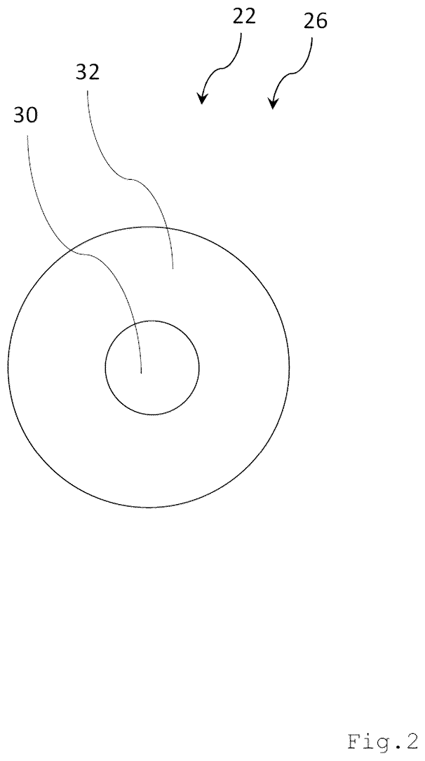

The method according to embodiments of the invention for laser-welding at least two conductor pieces 10, 16 is explained below with reference to FIGS. 1 and 2.

The method comprises the steps of:
providing an elongated first conductor piece 10 with a first end portion 12 and a first end face 14;
providing an elongated second conductor piece 16 with a second end portion 18 and a second end face 20. In the present case, the end portions 12, 18 and the two end faces 14, 20 are arranged adjacent to one another. There is a gap 15 between the two end faces 14, 20;

In the present case, the conductor pieces 10, 16 have a rectangular cross-section. Thus, in the present case, the two end faces 14, 20 also have a rectangular shape. In the present case, the two end faces 14, 20 each have four edges 38, which in each case represent an outer boundary of the end faces 14, 20.

After the two end faces 14, 20 are provided, a first laser spot 22 is produced on the first end face 14 in order to create a first weld pool 24. A second laser spot 26 is produced on the second end face 20 to create a second weld pool 28 (see FIG. 1).

The first laser spot 22 and the second laser spot 26 are produced simultaneously. The first weld pool 24 and the second weld pool 28 grow and merge to form a common weld pool (not shown).

In the present case, the first laser spot 22 and the second laser spot 26 each have a circular core region 30 and an annular ring region 32 (see FIG. 2). The average laser power density in the core region 30 is greater than the average laser power density in the ring region 32. In other words, the laser intensity in the core region 30 is greater than the laser intensity in the ring region 32.

In the present case, the first laser spot 22 is moved exclusively on the first end face 14. In the present case, the second laser spot 26 is moved exclusively on the second end face 20. This prevents the first laser spot 22 and the second laser spot 26 from moving across the gap 15. In the present case, the movement of the two laser spots 22, 26 is implemented here by means of a scanner optical unit, which is not shown.

The first laser spot 22 and the second laser spot 26 can each be moved back and forth along a straight line 34. The movement along the straight line 34 is indicated in FIG. 1 by means of a double arrow.

Alternatively, the first laser spot 22 and the second laser spot 26 can be moved along an elliptical path 36. The elliptical path 36 is schematically indicated in FIG. 1 by means of a dashed line. Paths with other geometric shapes are also conceivable.

The first laser spot 22 and the second laser spot 26 can be moved identically on their respective end faces 14, 20. In other words, the two laser spots 22, 26 can be moved at the same speed in the same direction.

In the present case, when moving the first laser spot 22 and the second laser spot 26, a distance to an edge 38 of the end face 14, 20 is always maintained. The distance is at least the magnitude of one diameter of the laser spot 22, 26 to the edge 38. In other words, the first laser spot 22 and the second laser spot 26 are each at least one (own) diameter away from the (nearest) edge 38 of the end face 14, 20. In other words, in the present case, the first laser spot 22 always has a distance to the nearest edge 38 of the first end face 14 that is at least the magnitude of one diameter of the first laser spot 22. Accordingly, in the present case, the second laser spot 26 always has a distance to the nearest edge 38 of the second end face 20 that is at least the magnitude of one diameter of the second laser spot 26.

The first laser spot 22 and the second laser spot 26 are identically designed in the present case (see FIG. 2). The two laser spots 22, 26 can be produced by means of an optical multi-fiber, in particular a 2-in-1 fiber (not shown).

The two laser spots 22, 26 can be produced by means of two laser beams guided parallel to one another. The two parallel-guided laser beams can in particular be designed as partial beams of a common laser beam (not shown), which are preferably produced by means of a beam splitter.

The average laser power density of the first laser spot 22 and/or the second laser spot 26, or their core regions 30 and/or their ring regions 32, can be varied, in particular oscillated. It is also conceivable that intensity ramps could be implemented from the core region 30 to the ring region 32 (or vice versa). In other words, the average laser intensity can be continuously increased (e.g., at the end of the welding process) and/or decreased (e.g., at the start of the welding process) from the core region 30 to the ring region 32.

It is also conceivable that the positions of the first laser spot 22 and/or the second laser spot 26 on the respective end faces 14, 20 are determined, in particular for position monitoring and control. This can be implemented by means of an optical sensor (not shown).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for laser-welding at least two conductor pieces, the method comprising:
providing an elongated first conductor piece having a first end portion and a first end face;
providing an elongated second conductor piece having a second end portion and a second end face, wherein the first end face is arranged adjacent to the second end face;
producing a first laser spot on the first end face to produce a first weld pool; and
producing a second laser spot on the second end face to produce a second weld pool, wherein the first laser spot and the second laser spot are produced simultaneously, the first weld pool and the second weld pool subsequently merging to form a common weld pool.

2. The method according to claim 1, wherein the first laser spot and/or the second laser spot has a core region and a ring region, an average laser power density in the core region being greater than an average laser power density in the ring region.

3. The method according to claim 1, further comprising:
moving the first laser spot exclusively on the first end face; and/or
moving the second laser spot exclusively on the second end face, wherein the first laser spot and/or the second laser spot are moved by a scanner optical unit.

4. The method according to claim 1, wherein the first laser spot and/or the second laser spot is moved back and forth along a straight line.

5. The method according to claim 1, wherein the first laser spot and/or the second laser spot is moved along a circular or elliptical path.

6. The method according to claim 4, wherein the first laser spot and the second laser spot are moved identically on the first end face and the second end face, respectively.

7. The method according to claim 3, wherein the first laser spot and/or the second laser spot is moved at a distance from an edge of the first end face or the second end face, wherein the distance between the first laser spot or the second laser spot and the edge of the first end face or the second end face is at least one diameter of the first laser spot or of the second laser spot.

8. The method according to claim 2, wherein the first laser spot and the second laser spot are produced by an optical multi-fiber, wherein the first laser spot and the second laser spot are identical.

9. The method according to claim 1, wherein the first laser spot and the second laser spot are produced by two laser beams guided parallel to one another.

10. The method according to claim 2, further comprising:
varying the average laser power density in the core region or the ring region of the first laser spot; and/or
varying the average laser power density in the core region or the ring region of the second laser spot.

11. The method according to claim 1, further comprising:
determining a first position of the first laser spot on the first end face and a second position of the second laser spot on the second end face using an optical sensor.

12. An assembly of at least two conductor pieces integrally bonded to one another by a method according to claim 1.

13. An apparatus for laser-welding at least two conductor pieces, the apparatus comprising:
a laser source configured to simultaneously produce a first laser spot and a second laser spot, and
a control device for controlling the apparatus, the control device being configured to carry out the method according to claim 1.

14. The apparatus according to claim 13, wherein the first laser spot and/or the second laser spot has a core region and a ring region, an average laser power density in the core region being greater than an average laser power density in the ring region.

15. A non-transitory computer-readable storage medium comprising program steps stored thereon, the program steps, when executed by one or more processors, causing performance of a method according to claim 1.
